(19) United States
(12) Patent Application Publication
(10) Pub. No.: US 2024/0173665 A1
(43) Pub. Date: May 30, 2024

(54) METHODS FOR CAPTURING CO2 FROM DILUTE CO2 STREAMS OF VARYING HUMIDITY, INCLUDING NATURAL GAS COMBINE CYCLE EXHAUST STREAMS AND AMBIENT AIR STREAMS USING KAUST-7 BASED PHYSISORBENTS

(71) Applicants: Saudi Arabian Oil Company, Dhahran (SA); King Abdullah University of Science and Technology, Thuwal (SA)

(72) Inventors: Mohamed EDDAOUDI, Thuwal (SA); Prashant BHATT, Thuwal (SA); Aqil JAMAL, Dhahran (SA)

(21) Appl. No.: 18/060,092

(22) Filed: Nov. 30, 2022

(51) Int. Cl. B01D 53/14; B01J 20/22

(52) U.S. Cl. CPC B01D 53/1418; B01J 20/226; B01D 2253/204; B01D 2256/10; B01D 2256/12

(57) ABSTRACT

A method for capturing carbon dioxide (CO₂) from a humid gas stream is provided. In certain embodiments, the gas stream is a humid natural gas combine cycle (NGCC) exhaust stream. In certain embodiments, the gas stream is a humid air stream. The humid gas stream comprises CO₂ and oxygen (O₂). In the method, the humid gas stream is contacted with a metal organic framework (MOF) material KAUST-7. The CO₂ from the humid gas stream is captured with the KAUST-7 MOF material to generate a CO₂-concentrated gas stream comprising approximately 1-30% of CO₂.

### FIELD OF THE DISCLOSURE

The present disclosure relates to methods for capturing CO₂ from a gas stream, and in particular methods for capturing CO₂ from a gas stream containing low CO₂ concentration with varying humidity, such as a natural gas combine cycle exhaust stream and ambient air.

### BACKGROUND OF THE DISCLOSURE

Reduction of carbon dioxide (CO₂) emissions into the atmosphere remains a top priority for combating global warming. CO₂ concentration in the atmosphere recently reached around 415 ppm and is increasing continuously at the rate of 2-3 ppm per year. These increases in atmospheric CO₂ concentration over the last century, mainly owing to industrial and vehicular CO₂ emissions, are directly related to global warming. If CO₂ emissions are not stopped or reduced drastically, the world will soon cross a tipping point of 450 ppm CO₂ concentration, which could lead to a series of environmental catastrophes.

Because the world likely will still be dependent on fossil fuels for the next few decades, CO₂ capture is an important technology for mitigating CO₂ emissions. Many efforts to develop material and technology to capture CO₂ from flue gas (industrial emission) as well as directly from air (direct air capture) have been undertaken in recent years. For instance, CO₂ capture from flue gas is currently done at 10-15% CO₂ concentration, and there are some emerging technologies for this purpose.

Direct air capture, however, is more complicated, as CO₂ needs to be captured from gas (air) having a CO₂ concentration of 400 ppm, more than 200 times lower than flue gas. The advantage of direct air capture is that capture can be carried out at any place in the world, and it can take care of emissions from diffuse sources like the transport sector. Among the investigated materials, liquid amines and other amine-based chemisorbents have shown promise for both of these applications. However, these chemisorbent materials require very high energy for regeneration (100-120 kj/mol), which would practically nullify the positive impact of CO₂ capture. Moreover, amine-based materials are prone to degradation and produce toxic decomposition products that can have a detrimental effect on the environment.

Another approach is to use physisorbent materials, where the driving force of CO₂ adsorption is nonbonding interaction between the physisorbent material and CO₂. Metal-organic framework (MOF) is a relatively new class of adsorbent that has received a lot of attention in recent times, mainly because of the crystalline and modular nature that can be used in a variety of applications ranging from separation, storage, catalysis, sensor, electrochemistry, etc. Over the years, many MOF materials have shown remarkable CO₂ capture properties.

CO₂ capture from Natural Gas Combined Cycle (NGCC) power plant is another challenging CO₂ capture application. NGCC is more efficient and environmentally friendly than traditional coal-based power stations, and thus most of the future fossil fuel-based power stations are expected to use natural gas. Consequently, there is a need for technology that can capture CO₂ from NGCC plants. However, currently there are no materials that can reliably and economically capture CO₂ from NGCC exhaust gas (e.g., 4% CO₂, 10-13% O₂). The main difficulties for NGCC CO₂ capture are low CO₂ concentration and high oxygen content of the exhaust gas stream. Most material does not fulfill the collective requirement of decent CO₂ capacity at 4% CO₂ concentration in the presence of moisture (humidity) and good oxygen stability at high temperatures.

In regard to the above background information, the present disclosure is directed to provide a technical solution for capturing CO₂.

### SUMMARY OF THE DISCLOSURE

According to a first aspect, a method for capturing CO₂ from a humid natural gas combine cycle (NGCC) exhaust stream is provided. In the method, the humid NGCC exhaust stream is contacted with a metal organic framework (MOF) material KAUST-7. The humid NGCC exhaust stream comprises approximately 1 to 5% of CO₂ and approximately 10-13% of oxygen (O₂). The CO₂ from the humid NGCC exhaust stream is then captured with the MOF material KAUST-7 to generate a CO₂-concentrated gas stream comprising approximately 1-30% of CO₂, where the relative humidity of the humid NGCC exhaust stream is approximately 45-75% at 20-85° C. In another aspect, the relative humidity of the humid NGCC exhaust stream is approximately 50-70% at 20-85° C. In another aspect, the relative humidity of the humid NGCC exhaust stream is approximately 55-65% at 20-85° C. In another aspect, the balance of the humid NGCC exhaust stream is N₂. In another aspect, the CO₂ is captured with the MOF material KAUST-7 at a temperature in the range of approximately 20-85° C. and a pressure in the range of approximately 1-5 bar.

In a second aspect, a method for capturing CO₂ from a humid air stream is provided. In the method, the humid air stream is contacted with a metal organic framework (MOF) material KAUST-7. The humid air stream comprises approximately 400-1000 ppm of CO₂ and approximately 20-25% of O₂. The CO₂ from the humid air stream is then captured with the MOF material KAUST-7 to generate a CO₂-concentrated gas stream comprising approximately 1-30% of CO₂. The relative humidity of the humid air stream is approximately 5-75% at 0-55° C. In another aspect, the humid air stream comprises approximately 400-800 ppm of CO₂. In another aspect, the relative humidity of the humid air stream is approximately 50-70% at 0-55° C. In another aspect, the relative humidity of the humid air stream is approximately 55-65% at 0-55° C. In another aspect, the balance of the humid air stream is N₂ and O₂. In another aspect, the CO₂ is captured with the MOF material KAUST-7 at a temperature in the range of approximately 0-55° C. and a pressure in the range of approximately 1-5 bar.

In certain embodiments, the MOF material KAUST-7 is in the form of pellets, laminates, or other structured forms. In certain embodiments, the MOF material KAUST-7 is pretreated at a temperature in the range of approximately 60-150° C. under dynamic vacuum or dry inert gas to remove any previously adsorbed molecules. In certain embodiments, the MOF material KAUST-7 comprises an organic binder or an inorganic binder.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

The processes of the present disclosure will be described in more detail below and with reference to the attached drawings.

FIG. 1 displays a bar graph showing that CO₂ adsorption capacity of KAUST-7 MOF remains the same after 10 cycles of oxygen exposure at high temperatures suggesting high oxygen stability of the material in accordance with one or more embodiments. Each cycle includes exposure of the sample to hot air at 110° C. for 60 minutes.

FIG. 2 displays a flow diagram showing steps of a method for capturing CO₂ from a humid gas stream using a KAUST-7 MOF physisorbent in accordance with one or more embodiments.

FIGS. 3A-3B display the results of (3A) a breakthrough experiment of KAUST-7 with 10% CO₂ (Balance N₂) and humidity (65% RH) with a flow rate of 5 cc/min and (3B) the corresponding TPD after CO₂ breakthrough in accordance with one or more embodiments.

FIGS. 4A-4B display the results of (4A) a breakthrough experiment of KAUST-7 with 10% CO₂ (Balance N₂) and humidity (65% RH) with a flow rate of 5 cc/min, stopped in between CO₂ and H₂O breakthrough, and (4B) the corresponding TPD in between CO₂ and H₂O breakthrough in accordance with one or more embodiments.

FIGS. 5A-5B display the results of (5A) a breakthrough experiment of KAUST-7 with 10% CO₂ (balance N₂) and humidity (65% RH) with a flow rate of 5 cc/min, stopped after H₂O breakthrough, and (5B) the corresponding TPD after H₂O breakthrough in accordance with one or more embodiments.

FIGS. 6A-6B display the results of (6A) a breakthrough experiment of KAUST-7 with 1% CO₂ (balance N₂) under dry conditions with a flow rate of 25 cc/min at 298 K, and (6B) the corresponding TPD after CO₂ breakthrough experiment in dry conditions in accordance with one or more embodiments.

FIGS. 7A-7B display (7A) a breakthrough experiment of KAUST-7 with 1% CO₂ (balance N₂) in the presence of humidity (50% RH) with a flow rate of 25 cc/min at 298 K, and (7B) the corresponding TPD after water breakthrough in accordance with one or more embodiments.

### DETAILED DESCRIPTION OF CERTAIN EMBODIMENTS OF THE DISCLOSURE

Disclosed herein are methods for capturing CO₂ from a gas stream containing low CO₂ concentration (400 ppm to 5% CO₂) with varying humidity. The CO₂ is captured from the humid gas stream using a metal organic framework (MOF) material, specifically a KAUST-7 (NbOFFIVE-1-Ni) physisorbent. In the method, the MOF KAUST-7 effectively captures CO₂ from gas streams with varying humidity, and the captured CO₂ can be thereby recovered in the form of a concentrated CO₂ stream (e.g., approximately 1-30% CO₂). In the methods, the gas stream can be a natural gas combine cycle (NGCC) exhaust stream or an ambient air stream with varying humidity, or a humid air stream, for example.

Direct air CO₂ capture and CO₂ capture from NGCC exhaust are considered very difficult compared to CO₂ capture from flue gas streams (10-15% CO₂). Moreover, CO₂ capture from humid gas streams has conventionally caused further difficulty, as moisture from H₂O molecules typically interferes with the capture capacity of conventional capture methods and other physisorbents. For example, liquid or solid-supported amines have previously been used in CO₂ capture methods, but they are susceptible to degradation as the amount of oxygen increases, which can lead to corrosion. Likewise, zeolites and other physisorbents are used in some conventional CO₂ capture methods, but can be vulnerable to interference from water, which can affect their capture capabilities. However, the present methods, which utilizes a KAUST-7 physisorbent, results in surprisingly effective CO₂ capture from NGCC exhaust streams and air streams, even when said streams are humid gas streams. As such, the present methods can further expand the range of CO₂ capture technologies and accelerate efforts to mitigate increasing CO₂ concentration in the atmosphere and the accompanying global warming.

These and other aspects of the present systems and methods are described in further detail below. Further, as used in the present application, the term “approximately” when used in conjunction with a numerical value refers to any number within about 5, 3 or 1% of the referenced numerical value, including the referenced numerical value.

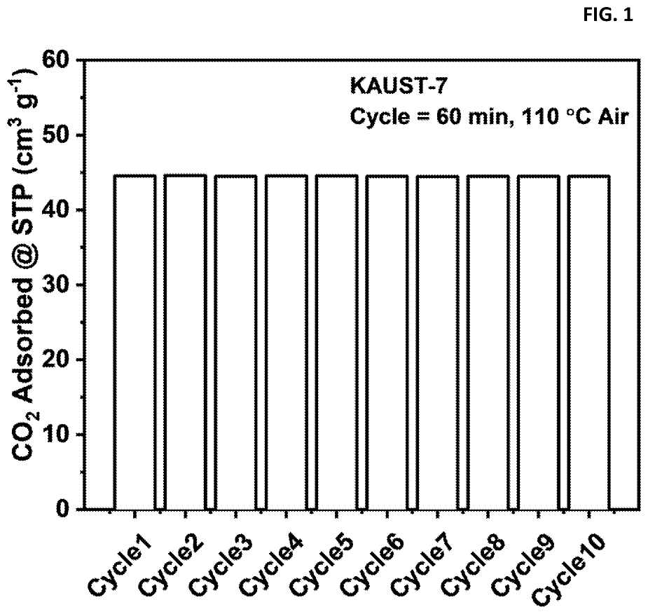

As mentioned above, in accordance with one or more embodiments, the CO₂ capture portion of the methods of the present application are performed using the MOF material KAUST-7 (NbOFFIVE-1-Ni; CAS: 1973399-07-3). KAUST-7 exhibits excellent O₂ stability at high temperatures, as exhibit in the example of FIG. 1. FIG. 1 displays a bar graph showing the results of an experiment evaluating the CO₂ adsorption capacity of KAUST-7 MOF with repeated exposure to O₂ at high temperatures. In the experiment, KAUST-7 MOF undergoes 10 cycles of O₂ exposure at high temperatures, where each cycle includes exposure of the KAUST-7 MOF sample to hot air at 110° C. for 60 minutes. As shown in the bar graph of FIG. 1, KAUST-7 exhibits consistent CO₂ adsorption capacity after 10 cycles of oxygen exposure at high temperatures, suggesting high oxygen stability of the KAUST-7 MOF material.

Moreover, unlike many other physisorbents, moisture interference in CO₂ capture is negligible with KAUST-7 MOF, which allows KAUST-7 MOF to be particularly well-suited for CO₂ capture from humid NGCC exhaust streams and other humid gas streams.

In one or more embodiments, the KAUST-7 MOF material is in the form of pellets, laminates, or other structured forms of the MOF such as a monolith or any other structured form to hold MOF particles in a particular shape. The KAUST-7 MOF material can also comprise one or more appropriate binders (e.g., organic or inorganic binders). In at least embodiment, the one or more binders can include but are not limited to one or more of the following: organic polymers (e.g., polyethylene, polystyrene, polyethylene glycol, polyvinyl alcohol, polysulfone, polymethylmethacrylate) and inorganic binders (e.g., kaolinite, gypsum). The KAUST-7 and binder composition can be in the range of 95:5 to 70:30. In at least one embodiment, cylindrical shaped pallets can be prepared with a composition that has 90% KAUST-7, and 10% of a polymethylmethacrylate type binder.

In one or more embodiments, the KAUST-7 MOF material of the present methods can be in a closed module that comprises the KAUST-7 MOF material and a binder. In at least one embodiment, the closed module can include one or more gas valves configured to manipulate the flow of the gas stream inside the module.

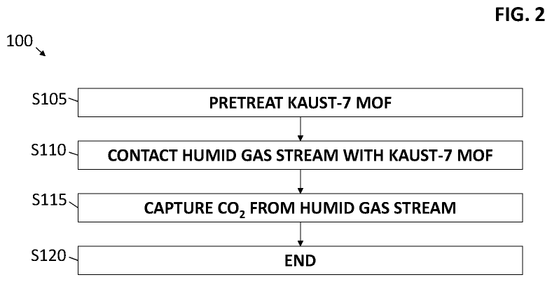

A flow diagram showing steps of the method for capturing CO₂ from a humid gas stream using the present KAUST-7 MOF physisorbent is provided in FIG. 2 in accordance with one or more embodiments. With reference now to the flow diagram of FIG. 2, the method 100 begins at a step S105 where the KAUST-7 MOF material is pretreated at a suitable temperature under airflow, vacuum, or other methods. In one or more embodiments, pretreatment of the KAUST-7 MOF material removes any previously adsorbed molecules such as H₂O and other guest molecules before the gas stream is introduced into the KAUST-7 MOF material. Pretreatment of the KAUST-7 MOF material can improves its ability to adsorb target molecules (e.g. CO₂) in the pores. In one or more embodiments, during pretreatment, the KAUST-7 MOF material is subjected to a temperature in the range of approximately 60-150° C. under dynamic vacuum or dry inert gas (e.g., N₂, O₂, Ar, He or air) flow. In an embodiment in which the KAUST-7 MOF material used is in a closed module in the present method, the pretreated KAUST-7 MOF material is incorporated into the closed module, along with a binder for example. In one or more embodiments, pretreatment of the KAUST-7 MOF material is performed after the KAUST-7 MOF material has been incorporated in the closed module.

In one or more embodiments, pretreatment of the KAUST-7 MOF material is optional, and as-made KAUST-7 MOF material can be loaded in a closed module.

With continued reference to FIG. 2, at step S110, a humid gas stream is introduced into the KAUST-7 MOF material. In one or more embodiments, the humid gas stream is a humid NGCC exhaust stream comprising approximately 1% to 5% of CO₂ and approximately 10-13% of O₂. In at least one embodiment, the humid NGCC exhaust stream comprises approximately 1-10% of CO₂ and approximately 10-13% of O₂. In one or more embodiments, the remainder or balance of the humid NGCC exhaust stream is N₂ (e.g., approximately 77% to approximately 89% of the NGCC exhaust stream). In one or more embodiments, the humid NGCC exhaust stream comprises approximately 400 ppm to 4%, 400 ppm to 3%, 400 ppm to 2%, 400 ppm to 1%, 1-5%, or 4% CO₂. In one or more embodiments, the relative humidity (RH) of the humid NGCC exhaust stream is approximately 45-75%, 45-70%, 50-70%, 50-65%, 50-60%, or 55-65% at 20-85° C. In at least one embodiment, the relative humidity of the humid NGCC exhaust stream is approximately 50% at 20-85° C. In at least one embodiment, the relative humidity of the humid NGCC exhaust stream is approximately 65% at 20-85° C. In one or more embodiments, the NGCC exhaust gas stream further comprises 2-10% H₂O vapor. In one or more embodiments, the NGCC exhaust gas can include other components such as small proportions of SO₂ and NOₓ.

In one or more embodiments, the humid gas stream can be first cooled to a suitable temperature (approximately 0-55° C.) before being contacted with the KAUST-7 MOF material. In at least one embodiment, the temperature during adsorption (capture) by the KAUST-7 MOF material is also in the same temperature range (e.g., approximately 0-55° C.) and the temperature of the incoming gas stream helps it to maintain the similar temperature.

In one or more embodiments, the humid gas stream is a humid air stream comprises approximately 400-1000 ppm, 400-900 ppm, 400-800 ppm, 400-700 ppm, 400-600 ppm, or 400-500 ppm of CO₂ and approximately 20-25% of O₂. In one or more embodiments, the balance of the humid air stream is N₂ and O₂. In one or more embodiments, the humid air stream comprises approximately 400 ppm of CO₂. In one or more embodiments, the relative humidity of the humid air stream is approximately 5-75%, 10-75%, 15-75%, 20-75%, 25-75%, 30-75%, 35-75%, 40-75%, 45-75%, 50-70%, 50-60%, or 55-65% at 0-55° C. In at least one embodiment, the relative humidity of the humid air stream is approximately 50% at 0-55° C. In at least one embodiment, the relative humidity of the humid air stream is approximately 65% at 0-55° C. In one or more embodiments, the humid air stream can be breathable air (e.g., atmospheric air), which can include one or more of nitrogen (N₂), oxygen (O₂), and argon (Ar) in addition to CO₂.

In one or more embodiments, the flow rate of the humid gas stream (e.g., humid air steam, humid NGCC exhaust stream) depends on the capacity of the plant (e.g., NGCC plant), and thus can be any flow rate of NGCC exhaust, for example.

Once the humid gas stream is contacted with the KAUST-7 MOF material, at step S115 the CO₂ in the humid gas stream is captured by the KAUST-7 MOF material. In one or more embodiments, the capturing of the CO₂ comprises physical adsorption of the CO₂ by the KAUST-7 MOF material. In one or more embodiments, the KAUST-7 MOF material has a CO₂ adsorption capacity in the range of approximately 0.5 wt %-10 wt %. In one or more embodiments, the KAUST-7 MOF material also becomes saturated with water under the humid conditions of the humid gas stream (humid NGCC exhaust stream, humid air stream).

In one or more embodiments, the CO₂ is captured by the KAUST-7 MOF material at a temperature in the range of approximately 20-85° C. from the humid NGCC exhaust stream. In one or more embodiments, the CO₂ is captured by the KAUST-7 MOF material at a temperature in the range of approximately 0-55° C. from the humid air stream.

In one or more embodiments, the CO₂ is captured from the humid gas stream by the KAUST-7 MOF material at a pressure in the range of approximately 1-5 bar.

In one or more embodiments, capturing the CO₂ can comprise wholly or partially containing the CO₂ within pores of the KAUST-7 MOF material.

In one or more embodiments, such as embodiments in which the KAUST-7 MOF is in a closed module, the capturing of the CO₂ results in the generation of a CO₂-free (or substantially CO₂-free) stream (i.e., the remainder of the gas stream from which the CO₂ was captured) in the KAUST-7-based closed module, and once the KAUST-7 MOF material is saturated with CO₂, the CO₂-free gas stream can be discharged from the closed module into the atmosphere, or optionally subjected to additional treatment, for example, to remove other components such as SO₂ and NOₓ.

In one or more embodiments, the captured CO₂ in the KAUST-7 MOF material can be later provided as a CO₂-rich stream (CO₂-concentrated gas stream). In one or more embodiments, hot air, hot nitrogen, vacuum, or other suitable methods, or a combination thereof can be used to recover the adsorbed CO₂ from the KAUST-7 MOF material to produce the CO₂-rich gas stream. In one or more embodiments, the generated CO₂-rich stream comprises approximately 1-30% of CO₂. In one or more embodiments, the generated CO₂-rich stream comprises approximately 5-30% of CO₂, 10-30% of CO₂, 15-30% CO₂, 20-30% CO₂, 1-20% of CO₂, 5-20% of CO₂, or 10-20% of CO₂. In at least one embodiment, the generated CO₂-rich stream can be later purified directly (CO₂ purification) or can be mixed with another stream of industrial exhaust with similar CO₂ concentrations before purification. In one or more embodiments the generated CO₂-rich stream is subsequently purified to result in a pure or substantial pure (at least 90%) CO₂ stream. Purification of the CO₂-rich stream can be done via a CO₂ purification unit or via other technologies as known in the art.

In at least one embodiment, the generated CO2-rich stream is not subsequently purified, and can be used as is for future applications, such as in the greenhouse for better yield of agricultural product.

By capturing the CO₂ via adsorption, the KAUST-7 MOF material becomes saturated. In at least one embodiment, once the MOF material is saturated with CO₂, the humid gas stream is stopped from contacting the KAUST-7 MOF material. In at least one embodiment, such as when the KAUST-7 MOF material is part of a closed module, the closed module can include one or more gas valves for receiving and dispersing of gas streams. The gas valves are configured to manipulate the flow of the gas stream inside the closed module. For example, in one or more embodiments, the gas stream is stopped from entering the closed module upon saturation of the KAUST-7 MOF material by closing one or more valves of the closed module. In at least one embodiment, the gas stream is stopped from entering the closed module by closing one or more valves of the NGCC exhaust unit.

Finally, at step S120, the method ends. In one or more embodiments, the length of time of a cycle of the CO₂ capture method of the present application can vary from approximately 1 minutes to approximately 30 minutes. However, it should be understood that in at least one embodiment, the length of time can vary even more that the above range based upon many factors, such as the amount of KAUST-7 material used, flow rate, etc.

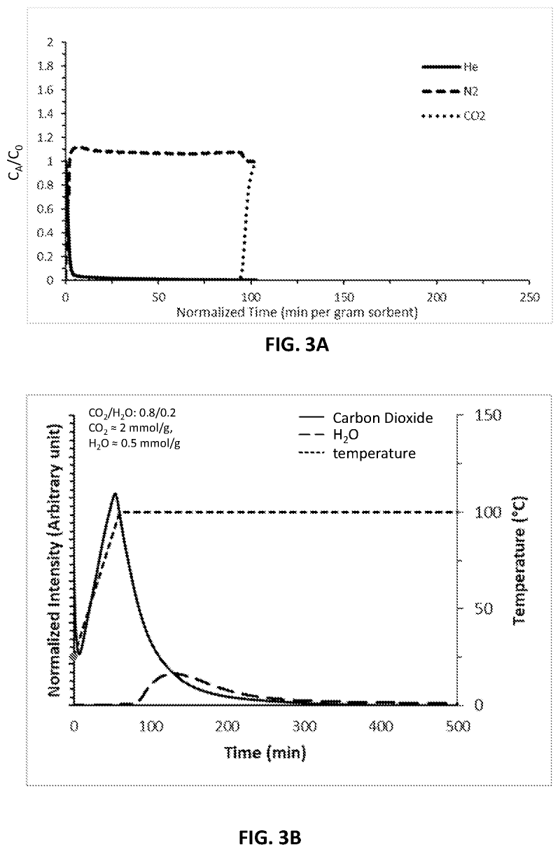

The aforementioned features and aspects of the present system and methods are further described in the following examples with reference to FIGS. 3-7. These examples utilize the exemplary MOF material of the present system and method, KAUST-7. As exemplified in FIGS. 3-7, KAUST-7 provides excellent CO₂ capture properties from humid streams and excellent oxygen stability.

### EXAMPLES

To understand H₂O/CO₂ co-adsorption with KAUST-7, humid CO₂ breakthrough experiments were performed, followed by adsorbed phase analysis using temperature-programmed desorption (TPD) experiments. Humid streams containing 10% and 1% CO₂ concentration were used for the experiments. The results indicate that humidity has a minimal impact on CO₂ capture capacity of the KAUST-7 MOF material even after water breakthrough (saturation of column with water vapor) for gas streams having between 1-10% CO₂ concentrations. Hence, it can be concluded that humidity has a minimal impact on CO₂ capture performance of KAUST-7 and KAUST-7 maintains good CO₂ capture performance under NGCC exhaust conditions (e.g., humid gas comprising approximately 4% CO₂).

Experiments with 10% CO₂ (Balance N₂) at 65% RH (FIGS. 3-5)

Breakthrough experiments were performed for KAUST-7 with a gas composition of 10% CO₂ (balance N₂) and humidity (65% RH) with a flow rate of 5 cc/min at 298 K. The breakthrough curve shows that CO₂ breaks at 94 min/g, equivalent to 2.0 mmol/g and water breaks at 526 min/g equivalent to 2.5 mmol/g. To gain more insights on the adsorbed phase compositions and if the CO₂ remains adsorbed after the water breakthrough, temperature-programmed desorption (TPD) was performed at different stages of the breakthrough experiment: 1) after CO₂ breakthrough, 2) in between CO₂ and H₂O breakthrough, and 3) after H₂O breakthrough.

### 1) After CO₂ Breakthrough (FIGS. 3A-3B)

FIGS. 3A-3B display the results of (FIG. 3A) the breakthrough experiment of KAUST-7 with 10% CO₂ (Balance N₂) and humidity (65% RH) with a flow rate of 5 cc/min and (FIG. 3B) the corresponding TPD after CO₂ breakthrough. The breakthrough experiment was stopped just after CO₂ breakthrough (≈94 min/g, ≈2.0 mmol/g). The TPD experiment was carried out immediately after and the adsorbed phase contains ≈2.0 mmol/g CO₂ and ≈0.5 mmol/g of H₂O.

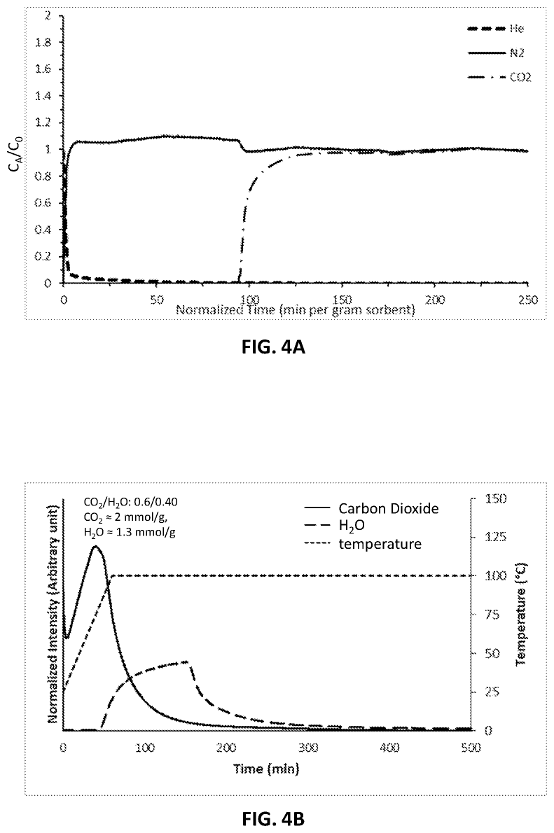

2) In Between CO₂ and H₂O Breakthrough (FIGS. 4A-4B)

FIGS. 4A-4B display the results of (FIG. 4A) the breakthrough experiment of KAUST-7 with 10% CO₂ (Balance N₂) and humidity (65% RH) with a flow rate of 5 cc/min, stopped in between CO₂ and H₂O breakthrough, and (FIG. 4B) the corresponding TPD in between CO₂ and H₂O breakthrough. The breakthrough experiment was stopped in between CO₂ and H₂O breakthrough after the normalized time of 250 min/g. The TPD experiment was carried out immediately after and the adsorbed phase contains ≈2.0 mmol/g CO₂ and ≈1.3 mmol/g of H₂O.

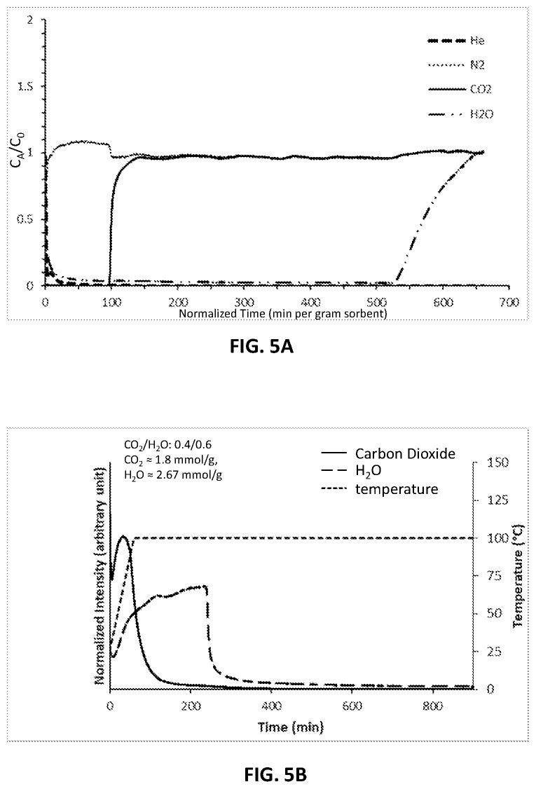

### 3) After H₂O Breakthrough (FIGS. 5A-5B).

FIGS. 5A-5B display the results of (FIG. 5A) the breakthrough experiment of KAUST-7 with 10% CO₂ (balance N₂) and humidity (65% RH) with a flow rate of 5 cc/min, stopped after H₂O breakthrough, and (FIG. 5B) the corresponding TPD after H₂O breakthrough. The breakthrough experiment was stopped after H₂O breakthrough (526 min/g, ≈2.5 mmol/g) at normalized time 660 min/g. The TPD experiment was carried out immediately after and the adsorbed phase contains ≈1.8 mmol/g CO₂ and ≈2.67 mmol/g of H₂O (FIG. 4).

It is evident from these experiments that under the above conditions (10% CO₂ in the presence of 65% RH humidity), CO₂ concentration in the adsorbed phase is minimally affected by water even after water breakthrough.

Experiments with 1% CO₂ (Balance N₂) Under Dry and Humid Conditions (50% RH)

Similar experiments were also performed with a gas comprising 1% CO₂ (balance N₂) under dry and humid conditions (50% RH).

### 1) 1% CO₂ Breakthrough Under Dry Conditions and Corresponding TPD

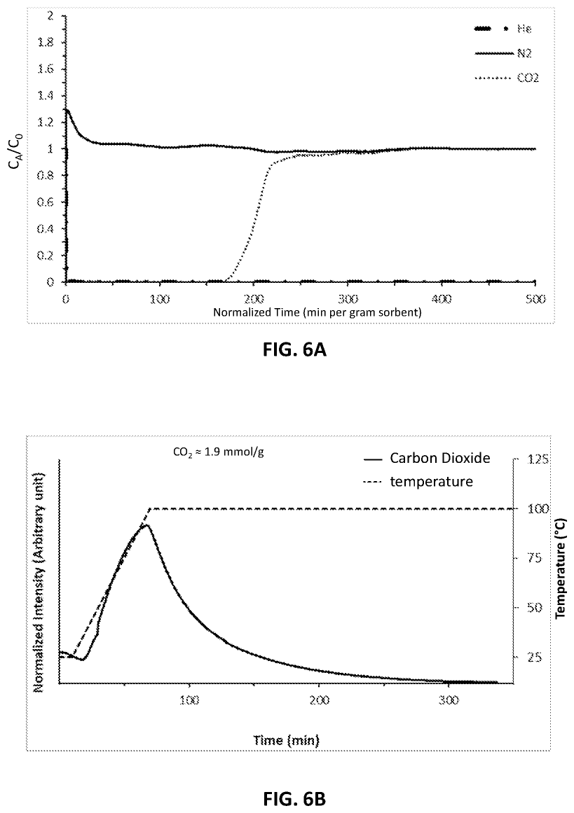

FIGS. 6A-6B display the results of (FIG. 6A) the breakthrough experiment of KAUST-7 with 1% CO₂ (balance N₂) under dry conditions with a flow rate of 25 cc/min at 298 K, and (FIG. 6B) the corresponding TPD after CO₂ breakthrough experiment in dry conditions, where the CO₂ breakthrough occurred at normalized time 170 g/min, which corresponds to 1.9 mmol/g CO₂ uptake. The TPD experiment was carried out after the breakthrough experiment.

### 2) 1% CO₂ Breakthrough Experiment in the Presence of Humidity (50% RH) and Corresponding TPD

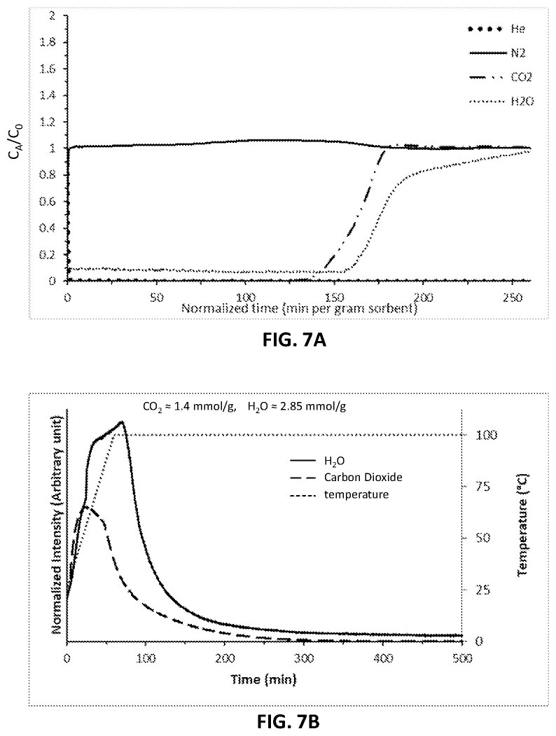

FIGS. 7A-7B displays (FIG. 7A) the breakthrough experiment of KAUST-7 with 1% CO₂ (balance N₂) in the presence of humidity (50% RH) with a flow rate of 25 cc/min at 298 K, and (FIG. 7B) the corresponding TPD after water breakthrough, where the CO₂ breakthrough occurred at normalized time 135 min/g (≈1.5 mmol/g CO₂), while H₂O breakthrough occurred at normalized time 155 min/g (≈2.6 mmol/g H₂O). The breakthrough experiment was stopped well after the H₂O breakthrough (normalized time 260 min/g) and TPD was carried out. The TPD experiment indicates that the adsorbed phase contains ≈1.4 mmol/g CO₂ and ≈2.85 mmol/g H₂O.

It is evident from the above experiments, in which the CO₂ concentration in the gas ranged from 10% to 1% in the presence of humidity, that CO₂ uptake at saturation (after water breakthrough) decreases as CO₂ concentration decreases. However, even for 1% CO₂ (50% RH) adsorbed phase contains 1.4 mmol/g of CO₂ after water breakthrough, which is surprising because, in most of the physisorbents, water replaces most of CO₂ at this concentration. These experiments indicate that KAUST-7 MOF exhibits good CO₂ uptake in the presence of humidity for gases having a low CO₂ concentration of 1%.

The results of the experiments also indicate that humidity has a minimal impact on the CO₂ capture capacity of KAUST-7 MOF even after water breakthrough (saturation of column with water vapor) between 1-10% CO₂ concentrations, which demonstrates that CO₂ capture performance of KAUST-7 is maintained under NGCC exhaust conditions (e.g., 4% CO₂ humid gas).

As exemplified by the above experiments, the present methods provide remarkable CO₂ capture capabilities for humid gas streams. As such, the present methods are effective for CO₂ capture from NGCC exhaust streams, which results in positive environmental impacts. Specifically, NGCC is more efficient and environmental friendly than traditional coal-based power stations and will likely replace many coal-based power stations in the immediate future. As such, there is a need for technology that can capture CO₂ from NGCC plants. Before the present methods, conventional methods and materials have been unable to reliably and economically capture CO₂ from NGCC exhaust gas. However, as shown in the present application, the present methods utilizing KAUST-7 MOF exhibit excellent CO₂ capture properties for NGCC conditions and oxygen stability even at high temperatures.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for capturing CO₂ from a humid natural gas combine cycle (NGCC) exhaust stream, comprising:
contacting the humid NGCC exhaust stream with a metal organic framework (MOF) material KAUST-7, wherein the humid NGCC exhaust stream comprises approximately 1 to 5% of CO₂ and approximately 10-13% of O₂; and
capturing, with the MOF material KAUST-7, CO₂ from the humid NGCC exhaust stream to generate a CO₂-concentrated gas stream comprising approximately 10-30% of CO₂,
wherein the relative humidity of the humid NGCC exhaust stream is approximately 45-75% at 20-85° C.

2. The method of claim 1, wherein the relative humidity of the humid NGCC exhaust stream is approximately 50-70% at 20-85° C.

3. The method of claim 1, wherein the relative humidity of the humid NGCC exhaust stream is approximately 55-65% at 20-85° C.

4. The method of claim 1, wherein the balance of the humid NGCC exhaust stream is N₂.

5. The method of claim 1, wherein the CO₂ is captured with the MOF material KAUST-7 at a temperature in the range of approximately 20-85° C. and a pressure in the range of approximately 1-5 bar.

6. The method of claim 1, wherein the MOF material KAUST-7 is in the form of pellets, laminates, or other structured forms.

7. The method of claim 1, wherein the MOF material KAUST-7 is pretreated at a temperature in the range of approximately 60-150° C. under dynamic vacuum or dry inert gas to remove any previously adsorbed molecules.

8. The method of claim 1, wherein the MOF material KAUST-7 comprises an organic binder or an inorganic binder.

9. A method for capturing CO₂ from a humid air stream, comprising:
contacting the humid air stream with a metal organic framework (MOF) material KAUST-7, wherein the humid air stream comprises approximately 400-1000 ppm of CO₂ and approximately 20-25% of O₂; and
capturing, with the MOF material KAUST-7, CO₂ from the humid air stream to generate a CO₂-concentrated gas stream comprising approximately 1-30% of CO₂,
wherein the relative humidity of the humid air stream is approximately 5-75% at 0-55° C.

10. The method of claim 9, wherein the humid air stream comprises approximately 400-800 ppm of CO₂.

11. The method of claim 9, wherein the relative humidity of the humid air stream is approximately 50-70% at 0-55° C.

12. The method of claim 9, wherein the relative humidity of the humid air stream is approximately 55-65% at 0-55° C.

13. The method of claim 9, wherein the balance of the humid air stream is N₂ and O₂.

14. The method of claim 9, wherein the CO₂ is captured with the MOF material KAUST-7 at a temperature in the range of approximately 0-55° C. and a pressure in the range of approximately 1-5 bar.

15. The method of claim 9, wherein the MOF material KAUST-7 is in the form of pellets, laminates, or other structured forms.

16. The method of claim 9, wherein the MOF material KAUST-7 is pretreated at a temperature in the range of approximately 60-150° C. under dynamic vacuum or dry inert gas to remove any previously adsorbed molecules.

17. The method of claim 9, wherein the MOF material KAUST-7 comprises an organic binder or an inorganic binder.
